(19) United States
(12) Patent Application Publication
(10) Pub. No.: US 2026/0106907 A1
(43) Pub. Date: Apr. 16, 2026

(54) METHOD AND SYSTEM FOR MANAGING COMMUNICATION IN USER EQUIPMENT HAVING PLURALITY OF SUBSCRIBER IDENTITY MODULES

(71) Applicant: SAMSUNG ELECTRONICS CO., LTD., Suwon-si (KR)

(72) Inventors: Kaja Mohaideen MOHAMED ALI, Bangalore (IN); Madhusudan Gorur MANJUNATH, Bangalore (IN); Sunil Kumar NAGARAJU, Bangalore (IN); Nitin Balaji SONTAKKE, Bangalore (IN); Mohammed ZEESHAN, Bangalore (IN)

(73) Assignee: SAMSUNG ELECTRONICS CO., LTD., Suwon-si (KR)

(21) Appl. No.: 19/420,128

(22) Filed: Dec. 15, 2025

Related U.S. Application Data
(63) Continuation of application No. PCT/KR2024/013985, filed on Sep. 13, 2024.

(30) Foreign Application Priority Data
Sep. 22, 2023 (IN) 202341063776
Aug. 14, 2025 (IN) 202341063776

(51) Int. Cl. H04L 65/1096; H04L 65/1016; H04L 65/1073; H04W 4/16; H04W 68/12; H04W 88/06

(52) U.S. Cl. CPC H04L 65/1096; H04L 65/1016; H04L 65/1073; H04W 4/16; H04W 68/12; H04W 88/06

(57) ABSTRACT

A method performed by a user equipment (UE) having a plurality of subscriber identity modules (SIMs) comprising a first SIM and a second SIM, includes: performing a connection establishment procedure for a first call associated with the first SIM; detecting, while the first call is provided on the first SIM, an internet protocol multimedia subsystem (IMS) event associated with the second SIM; and based on the detecting the IMS event, enabling a cross-SIM calling for the second SIM based on information associated with the IMS event.

### CROSS-REFERENCE TO RELATED APPLICATIONS

This application is a by-pass continuation application of International Application No. PCT/KR2024/013985, filed on Sep. 13, 2024, which is based on and claims priority to Indian Provisional Patent Application No. 202341063776, filed on Sep. 22, 2023, and Indian Complete patent application No. 202341063776, filed on Aug. 14, 2024, in the Indian Intellectual Property Office, the disclosures of which are incorporated by reference herein their entireties.

### BACKGROUND

### 1. Field

The present disclosure relates to cross-subscriber identity module (SIM) calling, and more particularly, to methods and systems for managing communication in user equipment (UE) having a plurality of SIMs.

### 2. Description of Related Art

With the emergence of ‘Dual SIM Dual Standby’ (DSDS) technology, users may utilize two SIMs within a single user device. However, considering that conventional DSDS devices have one transceiver and two receiving antennas, if one of the SIMS, for example, SIM1, is on a voice call, another SIM, i.e., SIM2, enters into standby mode with limited connectivity. Therefore, only one SIM can be active for calls at a time.

FIGS. 1A and 1B are schematic diagrams 100-1 and 100-2 depicting limitations of DSDS technology, according to related art. As depicted in FIGS. 1A and 1B, a DSDS enabled user device 101 is equipped with a first SIM card (SIM1) 103 and a second SIM card (SIM2) 105. As depicted in FIG. 1A, while an active call is in progress on the SIM1 103, the SIM2 105 remains inactive, and thus, is unable to receive incoming calls. Additionally, the delivery of messages to the SIM2 103 may be subject to delays. Consequently, as depicted in FIG. 1B, the user device 101 is unable to receive a call from a first caller device 109 on the SIM2 105 while a call is active on SIM1 103 with a second caller device 107. Further, the delivery of short message service (SMS) on the inactive SIM (SIM2 105) may also be delayed.

The above-mentioned limitation of DSDS may be overcome by enabling the cross-SIM calling for the inactive SIM during the standby mode as described below in conjunction with FIG. 2.

FIG. 2 is a schematic diagram 200 depicting a feature of a cross-SIM calling, according to the related art. The feature of the cross-SIM calling is utilized to keep both the SIMs of a DSDS device in always reachable states. As depicted in FIG. 2, SIM1 103 in the user device 101 may become inactive when the second SIM (SIM2) 105, which is registered on a corresponding second network 203, may be engaged in a call. In such case, the inactive SIM1 103 cannot receive calls until the call on the other SIM (SIM2) 105 ends, which may lead to a undesirable situation where the user may miss important or emergency calls or SMS, which may result in poor user experience. To enhance user experience, the cross-SIM calling enables the inactive SIM (in this case, SIM1) to remain registered on the corresponding first network 201 by utilizing the data connection of SIM2 105. This scheme may allow the inactive SIM to become reachable even when the inactive SIM is not actively engaged, ensuring that both SIMs maintain their connectivity. However, enabling the cross-SIM calling may lead to high power consumption.

According to the related art, as depicted in FIG. 2, the call on SIM2 105 of user device 101 is established using ‘mobility management entity’ (MME), ‘serving call session control function’ (S-CSCF), and ‘proxy call session control function’ (P-CSCF). Further, when a second call is made on SIM1 103, the MME in conjunction with home subscriber server (HSS) and other network elements, determines if cross-SIM calling is enabled for the user device 101. Further, the network allocates necessary resources for the second call on the SIM 103 when the cross-SIM calling is determined to be enabled. Finally, S-CSCF and P-CSCF handle the setup of the second call on SIM1 103, similar to the first call on SIM2 105.

FIG. 3A is a schematic diagram 300-1 depicting an example power consumption by a user device when the cross-SIM calling feature is not enabled, according to the related art. FIG. 3B is a schematic diagram 300-2 depicting an example power consumption by the user device when the cross-SIM calling feature is enabled, according to the related art. The difference in power consumption by the user device in the two different modes (i.e., when the cross-SIM calling is not enabled as in FIG. 3A and when the cross-SIM calling is enabled as in FIG. 3B) is further represented below in Table 1. Table 1 represents a first example power consumption by the user device when the cross-SIM calling is enabled and a second example power consumption when the cross-SIM calling is not enabled.

TABLE 1

| | Power consumption | Power consumption | | Power |
|---|---|---|---|---|
| Call | (mAh) when cross- | (mAh) when cross- | Differ- | increase |
| Type | SIM is not enabled | SIM enabled | ence | (%) |
| Voice | 138.78 | 179.74 | 40.96 | 29.68 |
| (20 mins) | | | | |

As depicted in the table above, when the cross-SIM calling is not enabled, only one SIM is active at a time and the power consumption by the user device is 139.78 mAh. On the contrary, when the cross-SIM calling is enabled, during an active call on SIM1 103, SIM2 105 is registered through the data connection of SIM1 103, such that both SIM1 103 and SIM2 105 are reachable at all times. In such case, the power consumption by the user device exceeds by 40.96 mAh, i.e., 179.74 mAh. Therefore, the power consumption of the user device increases by approximately 30% when the cross-SIM calling is enabled as shown in FIG. 3B.

Therefore, even though the cross-SIM calling may overcome the connectivity issue of all the SIMs in the user device, excessive power consumption may discourage users from enabling the cross-SIM calling, which may result in a poor user experience.

Accordingly, there is a need to overcome or resolve the above-described limitations of the related art. Additionally, there is a need to provide schemes for preventing the excessive power consumption by the user device when the cross-SIM calling is enabled.

### SUMMARY

According to an aspect of the disclosure, a method performed by a user equipment (UE) having a plurality of subscriber identity modules (SIMs) including a first SIM and a second SIM, includes: performing a connection establishment procedure for a first call associated with the first SIM; detecting, while the first call is provided on the first SIM, an internet protocol multimedia subsystem (IMS) event associated with the second SIM; and based on the detecting the IMS event, enabling a cross-SIM calling for the second SIM based on information associated with the IMS event.

According to an aspect of the disclosure, a user equipment (UE) having a plurality of subscriber identity modules (SIMs) including a first SIM and a second SIM, includes: at least one processor including processing circuitry; and memory storing instructions that, when executed by the at least one processor individually or collectively, cause the UE to: perform a connection establishment procedure for a first call associated with the first SIM; detect, while the first call is provided on the first SIM, an internet protocol multimedia subsystem (IMS) event associated with the second SIM; and based on detecting the IMS event, enable a cross-SIM calling for the second SIM based on information associated with the IMS event.

According to an aspect of the disclosure, a non-transitory computer-readable storage medium storing instructions that, when executed by a processor, cause a user equipment (UE), having a plurality of subscriber identity modules (SIMs) including a first SIM and a second SIM, to perform operations including: performing a connection establishment procedure for a first call associated with the first SIM; detecting, while the first call is provided on the first SIM, an internet protocol multimedia subsystem (IMS) event associated with the second SIM; and based on the detecting the IMS event, enabling a cross-SIM calling for the second SIM based on information associated with the IMS event.

To further clarify the advantages and features of the present disclosure, a more particular description of the disclosure will be rendered by reference to specific embodiments thereof, which is illustrated in the appended drawing. These drawings depict only typical embodiments of the disclosure and are therefore not to be considered limiting the scope of the disclosure. The disclosure will be described and explained with additional specificity and detail with the accompanying drawings.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B are schematic diagrams depicting the limitations of dual subscriber identity module (SIM) dual standby (DSDS) technology, according to related art;

FIG. 2 is a schematic diagram depicting the enabling of cross-SIM calling, according to the related art;

FIG. 3A is a schematic diagram depicting an example power consumption by a user device when a cross-SIM calling feature is not enabled, according to the related art;

FIG. 3B is a schematic diagram depicting an example power consumption by the user device when the cross-SIM calling feature is not enabled, according to the related art;

FIG. 4 is a block diagram depicting the implementation of a system for managing communication in the UE having a plurality of SIMs, according to embodiments of the present disclosure;

FIG. 5 illustrates a block diagram depicting modules of the system for managing communication in the UE, according to an embodiment of the present disclosure;

FIG. 6 is a flow diagram depicting a method for managing communication in the UE having the plurality of SIMs, according to an embodiment of the present disclosure;

FIG. 7 is a schematic diagram depicting an example flow of operations for implementing the method for managing communication in the UE, according to an embodiment of the present disclosure;

FIG. 8 is a schematic diagram depicting another example flow of operations for implementing the method for managing communication in the UE, according to an embodiment of the present disclosure;

FIG. 9 is a schematic diagram depicting another example flow of operations for implementing the method for managing communication in the UE, according to an embodiment of the present disclosure; and

FIG. 10 is a schematic diagram depicting an example use case implementing the method for managing communication in the UE, according to an embodiment of the present disclosure.

In the drawings, like reference numerals refer to like elements. Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

A detailed methodology is explained in the following paragraphs of the disclosure.

An objective of the present disclosure may be to reduce power consumption and/or prevent excessive power consumption by a user equipment (UE) 401 when the cross-SIM calling is enabled.

The above-mentioned objective is achieved by providing a methodology for managing communication in the UE 401 having a plurality of SIMs. According to the methodology described in the present disclosure, the cross-SIM calling is enabled only when required, rather than keeping enabled throughout a call.

Embodiments of the present disclosure will be described below in detail with reference to the accompanying drawings.

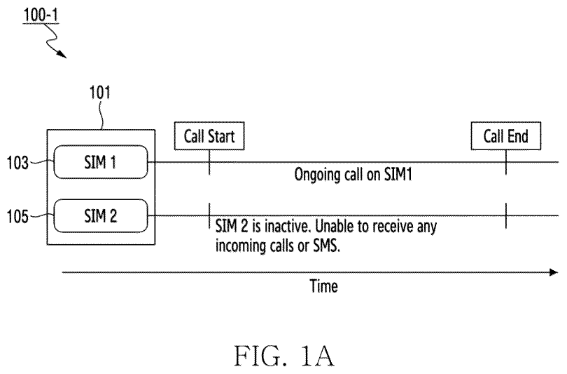

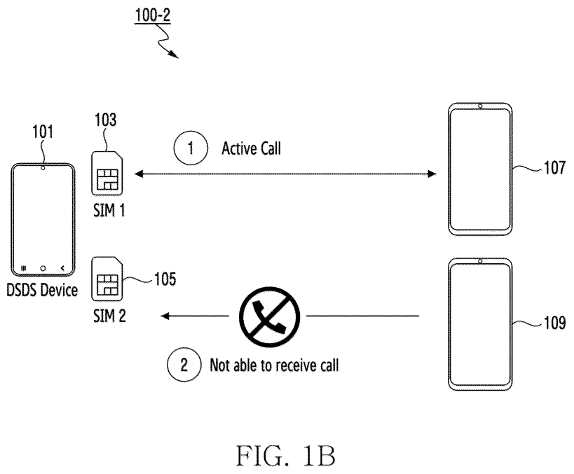

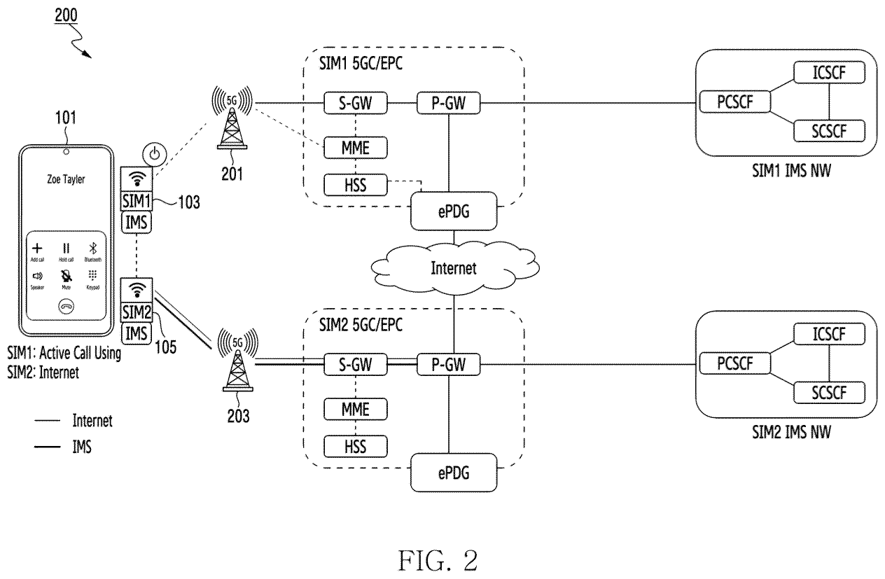

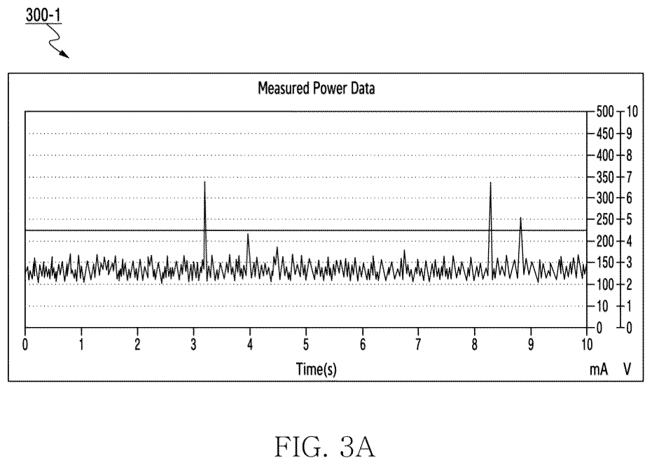

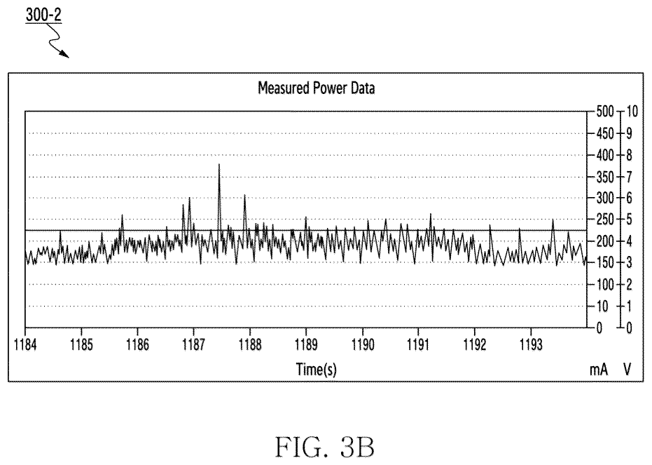

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

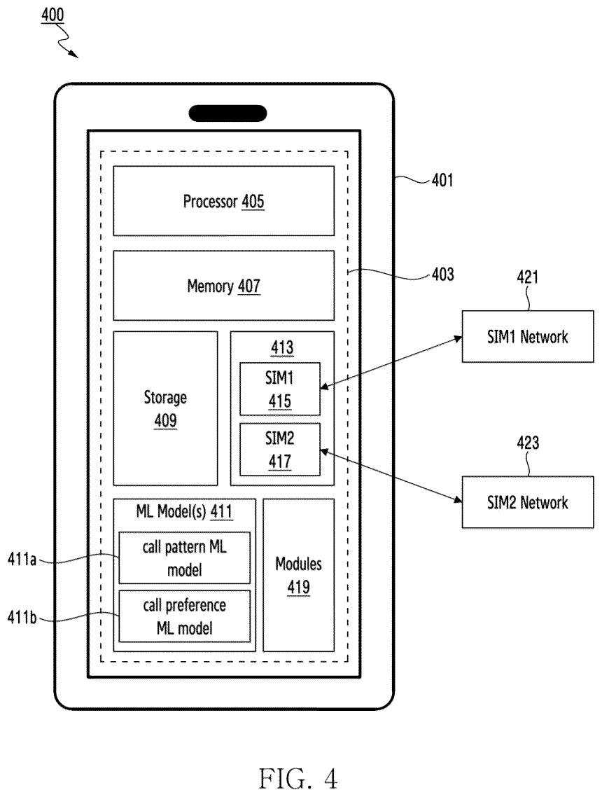

FIG. 4 is a block diagram 400 depicting the implementation of a system 403, for managing communication in the UE 401 having a plurality of SIMs, according to embodiments of the present disclosure. The UE 401 may be a DSDS-enabled user device and may include the system 403 for managing communication within the UE 401. The system 403 includes a processor 405, a memory 407, storage 409, a machine learning (ML) model(s) 411, modules 419, and a plurality of SIMs 413. The ML models may include a call pattern ML model 411a, and a call preference ML model 411b.

In an example, the processor 405 may be a single processing unit or a number of units, all of which could include multiple computing units. The processor 405 may be implemented as one or more microprocessors, microcomputers, microcontrollers, digital signal processors, central processing units, logical processors, virtual processors, state machines, logic circuitries, and/or any devices that manipulate signals based on operational instructions. For example, the processor 405 may include processing circuitry. Among other capabilities, the processor 405 is configured to fetch and execute computer-readable instructions and data stored in the memory 407.

The memory 407 may include any non-transitory computer-readable medium known in the art including, for example, volatile memory or Random Access Memory (RAM), such as static random access memory (SRAM) and dynamic random access memory (DRAM), and/or non-volatile memory, such as read-only memory (ROM), erasable programmable ROM, flash memories, hard disks, optical disks, and magnetic tapes.

At least one of a plurality of operations of the system 403 may be implemented through the ML model(s) 411. A function associated with AI may be performed through the non-volatile memory, the volatile memory, and the processor 405.

The processor 405 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). Any of the functions or operations described herein can be processed by one processor or a combination of processors. The one processor or the combination of processors is circuitry performing processing and includes circuitry like an application processor (AP, e.g., CPU), a communication processor (CP, e.g., a modem), a GPU, a NPU (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that, by applying a learning technique to a plurality of learning data, a predefined operating rule or AI model of a desired characteristic is made. The learning may be performed in a device itself in which AI according to an embodiment is performed, and/or may be implemented through a separate server/system.

The ML model(s) 411 refers to one or more machine learning models pre-trained using predetermined neural network techniques. The ML model(s) 411 includes the call pattern ML model 411a, and a call preference ML model 411b. In an embodiment, the call pattern ML model 411a may correspond to an ML model pre-trained to learn patterns of calling events at the UE 401. In an embodiment, the call preference ML model 411b may correspond to another ML model pre-trained to determine whether to enable the cross-SIM calling on the UE 401 based on pattern prediction by the call pattern ML model 411a.

The ML model(s) 411 may consist of a plurality of neural network layers. Each layer has a plurality of weight values and performs a layer operation through the calculation of a previous layer and an operation of a plurality of weights. Examples of neural networks include but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to decide or predict. Examples of learning techniques include, but are not limited to, supervised learning, unsupervised learning, semi-supervised learning, or reinforcement learning.

The ML model(s) 411 may be obtained by training. Here, “obtained by training” means that a predefined operation rule or artificial intelligence model configured to perform a desired feature (or purpose) is obtained by training a basic AI model with multiple pieces of training data by a training technique. The AI model may include a plurality of neural network layers. Each of the plurality of neural network layers includes a plurality of weight values and performs neural network computation by computation between a result of computation by a previous layer and the plurality of weight values.

The storage 409 may include the ML model(s) 411, one or more database repositories for storing data, such as ML data, intermediate data generated during the execution of the ML model(s) 411, or an outcome of the execution of the ML model(s) 411.

The plurality of SIMs 413 may include at least a first SIM (SIM1) 415, and a second SIM (SIM2) 417. The UE 401 may utilize SIM1 415 for communication, such as making or receiving calls and sending or receiving an SMS, via the corresponding service provider network, SIM1 network 421. Further, the UE 401 may utilize SIM2 417 for communication via the corresponding service provider network, SIM2 network 423. Although two SIMs are exemplified in the present disclosure, embodiments of the present disclosure are not limited thereto. A UE including three or more SIMs and a cross-SIM calling operation using the SIMs can also be understood as an embodiment of the present disclosure.

As an example, the module(s) 419 may include a program, a subroutine, a portion of a program, a software component, or a hardware component capable of performing a stated task or function. As used herein, the module(s) 419 may be implemented on a hardware component such as a server independently of other modules, or a module can exist with other modules on the same server, or within the same program. The module(s) 419 may be implemented on a hardware component, such as processor one or more microprocessors, microcomputers, microcontrollers, digital signal processors, central processing units, state machines, logic circuitries, and/or any devices that manipulate signals based on operational instructions. The modules 419 when executed by the processor 405 may be configured to perform any of the functionalities discussed herein.

In an embodiment, the module(s) 419 may be implemented using one or more artificial intelligence (AI) modules that may include a plurality of neural network layers. Examples of neural networks include but are not limited to, Convolutional Neural Network (CNN), Deep Neural Network (DNN), Recurrent Neural Network (RNN), and Restricted Boltzmann Machine (RBM). Further, ‘learning’ may be referred to in the disclosure as a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model.

A function associated with an AI module may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor, such as a neural processing unit (NPU). One or a plurality of processors control the processing of the input data in accordance with a predefined operating rule or artificial intelligence (AI) model stored in the non-volatile memory and the volatile memory. The predefined operating rule or artificial intelligence model is provided through training or learning.

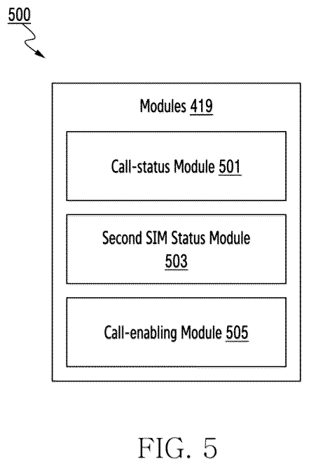

The modules 419 may include a set of instructions that may be executed according to the embodiments of the present disclosure to manage communication in the UE 401. The modules 419 are described in the forthcoming paragraphs in detail in conjunction with FIG. 5.

FIG. 5 illustrates a block diagram 500 depicting modules 419 of the system 403 for managing communication in the UE 401, according to an embodiment of the present disclosure. According to embodiments of the present disclosure, the modules 419 include a call-status module 501, a second SIM status module 503, and a call-enabling module 505.

In some embodiments, the modules 419, the call-status module 501, the second SIM status module 503, or the call-enabling module 505 may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). In some embodiments, the modules 419, the call-status module 501, the second SIM status module 503, or the call-enabling module 505 may be implemented by components such as software components, object-oriented software components, class components, and task components, processes, functions, attributes, procedures, sub-routines, segments of a program code, drivers, firmware, a micro code, a circuit, data, a database, data structures, tables, arrays and parameters. In some embodiments, the modules 419, the call-status module 501, the second SIM status module 503, or the call-enabling module 505 may be implemented by combination of the above hardware components and the software components.

According to embodiments to the present disclosure, the call-status module 501 may be configured to identify an occurrence of a current calling event associated with the first SIM (SIM1) 415 among the plurality of SIMs 413 of the UE 401. In an embodiment, the current calling event may correspond to an ongoing voice call or an ongoing video call via the SIM1 415 using the SIM1 network 421. According to embodiments of the present disclosure, the SIM2 417 may become inactive during the current calling event via the SIM1 415.

According to embodiments to the present disclosure, the call-status module 501 may be configured to monitor the reception of paging messages for the second SIM (SIM2 417) from a connected network, i.e., SIM2 network 423. Further, the call-status module 501 may be configured to determine a paging cause associated with a received paging message. In an embodiment, determining the paging cause may include determining whether the paging message originated due to an ‘internet protocol multimedia subsystem’ (IMS) event.

In an example, the IMS event may correspond to a specific occurrence or change in the IMS network that triggers one or more actions. In an example, the IMS event may include, but is not limited to, video call, voice call, SMS over IP (SMSoIP), supplementary services (USSD), and rich communication services (RCS).

According to the third-generation partnership projects (3GPP) specification, 3GPP technical specification (TS) 36.331 version 17.0.0 or later version/3GPP TS 38.331 version 17.0.0 or later version, for ‘voice over long-term evolution’ (VOLTE)/‘voice over new radio’ (VoNR), the paging message is used for the notification of one or more UEs. The paging message is transmitted through a paging control channel as a logical channel. A paging cause of the paging control channel may indicate if the paging messages are originated due to the IMS event. For example, in 3GPP TS 36.331, the paging message includes information on a paging cause as an information element (IE). The paging cause IE indicates whether the paging message is originated due to an IMS voice. If the field is present, it may imply that the corresponding paging entry is for IMS voice. If upper layers indicate the support of paging cause and if this field is not present but ‘pagingRecordList-v1700’ IE is present, it implies that the corresponding paging entry is for a service other than the IMS voice. Otherwise, the paging cause is undetermined. For example, in 3GPP TS 38.331, the paging message includes information on a paging cause as an information element (IE). The paging cause IE indicates whether the paging message is originated due to the IMS voice. If the field is present, it may imply that the corresponding paging entry is for the IMS voice. If upper layers indicate the support of paging cause and if this field is not present but ‘pagingRecordList-v1700’ IE is present, it may imply that the corresponding paging entry is for a service other than the IMS voice. Otherwise, the paging cause is undetermined.

According to the 3GPP specification, when a call or an SMS is received for an inactive SIM (SIM2) of the UE 401, the connected network (SIM2 network 423) may send a network paging message to indicate that an event is waiting in an associated network server for the particular SIM (i.e., SIM2). In an example, during an ongoing call via SIM1 415, a caller device may initiate a VoNR call to connect with the UE 401 via SIM2 417. According to the 3GPP specification, the SIM2 network 423 may send a paging message to the UE 401. According to embodiments to the present disclosure, the call-status module 501 may determine a paging cause associated with the paging message.

According to embodiments to the present disclosure, the second SIM status module 503 may be configured to detect during the occurrence of the current calling event, the IMS event associated with the SIM2 among the plurality of SIMs of the UE 401. According to embodiments to the present disclosure, the IMS event may be detected based on the determined paging cause.

According to embodiments to the present disclosure, in the example, when the caller device initiates the VoNR call to connect with the UE 401 via SIM2 417, the second SIM status module 503 may detect the IMS event based on the paging cause, determined by the call-status module 501, associated with the paging message. In an example, based on the paging cause, the second SIM status module 503 may detect that an unsuccessful attempt of VoNR call are made to SIM2 417.

According to embodiments to the present disclosure, the call-enabling module 505 may be configured to enable, in response to detecting the IMS event, a cross-SIM calling for the second SIM (SIM2 417) based on information associated with the IMS event (SIM2 417). According to embodiments to the present disclosure, enabling the cross-SIM calling includes registering IMS services of the second SIM (SIM2 417) using a data connection of the first SIM (SIM1 415).

In an embodiment, enabling the cross-SIM calling includes determining, via the call pattern ML model 411a, a pattern for one or more calling events at the UE 401. In an embodiment, the call pattern ML model 411a may determine the pattern based on the usage history of the UE 401 associated with the plurality of SIMs 413. The pattern may correspond to a nature, a duration, and a frequency of the one or more calling events at the UE 401. Table 2 below represents an example pattern of outgoing and incoming calls on the plurality of SIMs 413 in the UE 401.

TABLE 2

| Patterns | SIM1 | SIM2 |
|---|---|---|
| Call Start | High from 9 AM to 6 PM | High in the evenings from |
| Hour | | 6 PM and after |
| Call Start | High on Weekdays | High on Weekends |
| Day | | |
| Type of Call | More outgoing calls | Balanced incoming and |
| | | outgoing |
| Number of | High number of distinct | Few distinct contacts (e.g., |
| Distinct | contacts (e.g., 50+) | 10-30) |
| Contacts | | |
| Call | High number of calls per | Low number of calls per day |
| Frequency | day (e.g., 20-30) | (e.g., 5-10) |
| Average Call | Long average duration | Short average duration (e.g., |
| Duration | (e.g., 20-30 mins) | 10-15 mins) |
| Time Since | Shorter, occur at regular | Long and occur at irregular |
| Last Call | intervals (e.g., every 30-40 | intervals |
| | mins) | |

As depicted in the above table 2, the SIM1 415 may be utilized for business usage, and the SIM2 417 may be used for personal usage. According to the embodiments of the present disclosure, the call pattern ML model 411a may determine corresponding patterns of outgoing and incoming calls based on the usage of the respective SIMs. In an example, the call pattern ML model 411a may determine that the SIM2 417 receives a higher number of calls on weekends and in the evening from 6 μm and after, whereas SIM1 415 receives a higher number of calls on weekdays and during daytime between 9 am and 6 μm. In an example, the call pattern ML model 411a may determine that the SIM2 417 has a balanced usage for receiving incoming and making outgoing calls, whereas SIM1 415 has a higher usage for making outgoing calls than receiving incoming calls. Further, based on the determined pattern, the call preference ML model 411b may determine whether to enable the cross-SIM calling.

In an embodiment, the call pattern ML model 411a may predict at least one of the duration and nature of the current calling event based on the determined pattern of the one or more calling events at the UE 401. For example, when the SIM1 415 is used for an outgoing call at 10 am, on a weekday, the call pattern ML model 411a may predict that the current ongoing call may be a business call and may last for 20-30 minutes. In an example, the call pattern ML model 411a makes the prediction based on the determined patterns associated with the SIM1 and SIM2 as depicted above in Table 2. In the present example, the SIM2 417 may become inactive during the ongoing call on SIM1 415.

Further, based on the at least one of the predicted duration and the predicted nature of the current calling event, the call-enabling module 505 may enable the cross-SIM calling. For example, based on the prediction that the current business call may last for 20-30 minutes, the call-enabling module 505 may enable the cross-SIM calling for the inactive SIM2 417. According to the embodiments of the present disclosure, cross-SIM calling may be enabled by registering IMS services of the inactive SIM (SIM2 417) using a data connection of the active SIM (SIM1 415).

In an embodiment, the cross-SIM calling may be enabled based on the determined paging cause. In an example, when the SIM1 415 is used for an outgoing call at 10 am, on a weekday, SIM2 417, may become inactive. Therefore, any attempt to make a call to SIM2 417 would be unsuccessful as the SIM2 417 would be unreachable. In an example, if such an unsuccessful attempt is made to the SIM2 417, a paging message may be received from the corresponding SIM2 network 423. According to the embodiments of the present disclosure, a paging cause associated with the received paging message is determined. Further, based on the paging cause, an IMS event associated with the inactive SIM2 417 is determined. Finally, the cross-SIM calling is enabled based on information associated with the IMS event.

In an embodiment, the cross-SIM calling is enabled by activating the second SIM (SIM2 417) from the inactive state. According to embodiments of the present disclosure, the second SIM may be activated by registering the IMS services of the SIM2 417 using the data connection of the first SIM (SIM1 415).

Consequent to activating from the inactive state, initiation of a second calling event, apart from the current calling event, is allowed for the second SIM (SIM2 417). Therefore, a calling event may be received on the second SIM (SIM2 417) during an ongoing on the first SIM (SIM1 415).

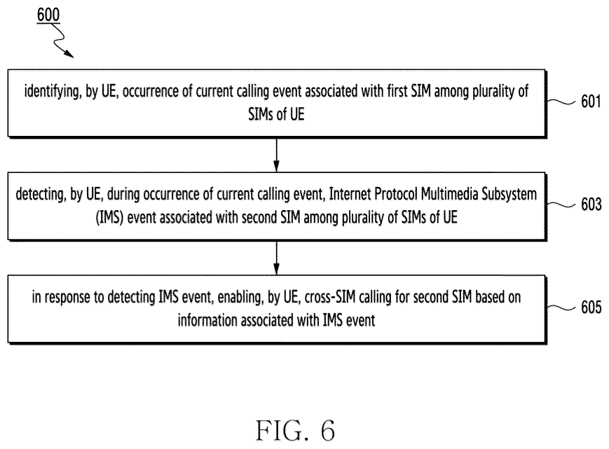

FIG. 6 is a flow diagram depicting a method 600 for managing communication in the UE 401 having the plurality of SIMs 413, according to an embodiment of the present disclosure. The method 600 includes a series of operations 601 through 605 executed by one or more components of the UE 401, in particular the processor 405.

At operation 601, the processor 405 identifies an occurrence of a current calling event associated with a first SIM 415 among the plurality of SIMs 413 of the UE 401.

At operation 603, the processor 405 detects, during the occurrence of the current calling event, the IMS event associated with the second SIM 417 among the plurality of SIMs 413 of the UE 401. In an embodiment, the reception of paging messages for the second SIM from a connected network is monitored. Further, a paging cause associated with a received paging message is determined. In an embodiment, determining the paging cause includes determining whether the paging message originated due to the IMS event. Furthermore, the IMS event is detected based on the determined paging cause.

At operation 605, the processor 405, in response to or based on detecting the IMS event, enables the cross-SIM calling for the second SIM 417 based on information associated with the IMS event. In an embodiment, enabling the cross-SIM calling is based on the paging cause.

In an embodiment, enabling the cross-SIM calling includes determining, via the call pattern ML model 411a, the pattern of one or more calling events at the UE, the pattern includes a nature, a duration, and a frequency of the one or more calling events at the UE 401, and determining, via the call preference ML model 411b, whether to enable the cross-SIM calling based on the determined pattern.

In an embodiment, enabling the cross-SIM calling includes predicting, via the call pattern ML model 411a, at least one of a duration and a nature of the current calling event based on the determined pattern of the one or more calling events at the UE 401, and enabling the cross-SIM calling based on the at least one of the predicted duration and the predicted nature of the current calling event.

In an embodiment, enabling the cross-SIM calling includes activating the second SIM 417 from an inactive state of the second SIM 417. In an embodiment, activating the second SIM 417 includes registering the IMS services of the second SIM using a data connection of the first SIM. Further, enabling the cross-SIM calling includes allowing the initiation of a second calling event, apart from the current calling event, for the second SIM of the UE 401.

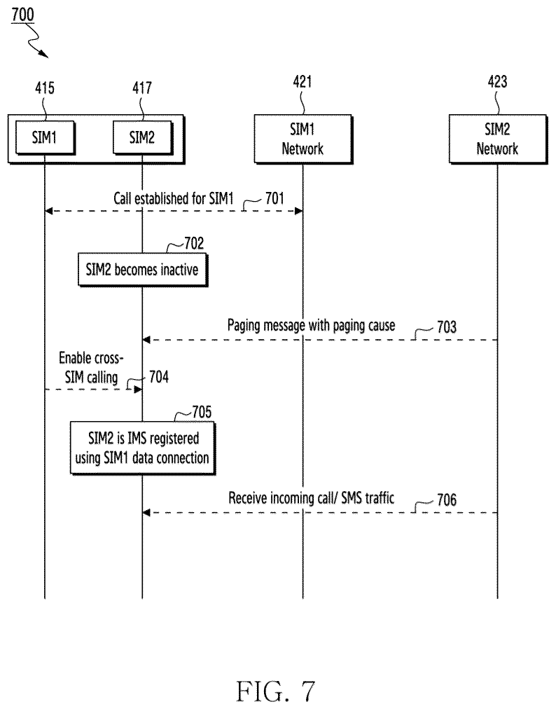

FIG. 7 is a schematic diagram 700 depicting an example flow of operations for implementing the method for managing communication in the UE 401, according to an embodiment of the present disclosure.

As depicted in FIG. 7, at operation 701, a call may be established using the SIM1 415. At operation 702, during the ongoing call on SIM1 415, the SIM2 417 becomes inactive.

In an example, at operation 703, a paging message with a paging cause may be received at the SIM2 417 from the corresponding SIM2 network 423. According to embodiments of the present disclosure, an IMS event associated with the SIM2 417 may be determined based on the paging cause.

At operation 704, in response to or based on determining the IMS event, cross-SIM calling may be enabled for the SIM2 417.

At operation 705, according to embodiments of the present disclosure, the cross-SIM calling is enabled by registering the IMS services of SIM2 417 using the data connection of SIM1 415. Consequently, the SIM2 417 becomes active and reachable.

At operation 706, the UE 401 is able to receive incoming calls or SMS.

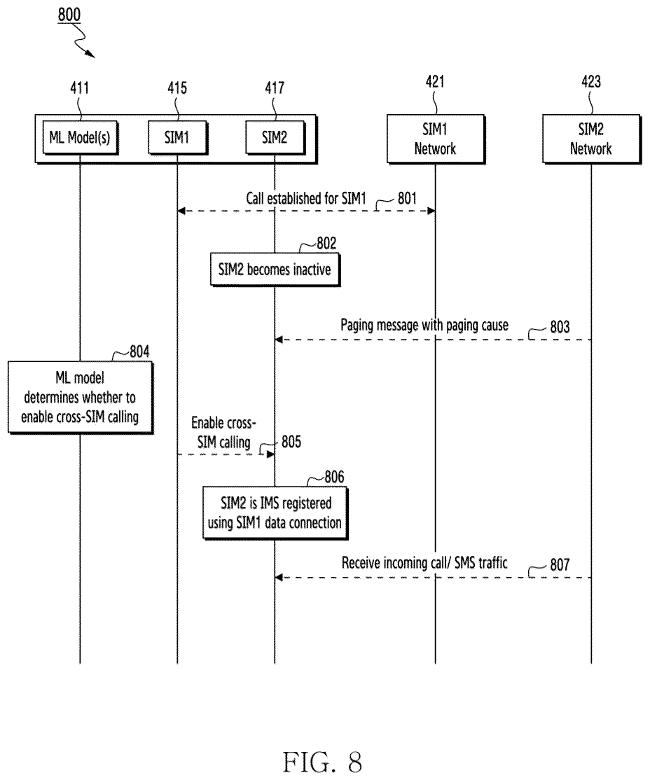

FIG. 8 is a schematic diagram 800 depicting another example flow of operations for implementing the method for managing communication in the UE 401, according to an embodiment of the present disclosure.

As depicted in FIG. 8, at operation 801, a call may be established using the SIM1 415. At operation 802, during the ongoing call on SIM1 415, the SIM2 417 becomes inactive.

In an example, at operation 803, a paging message with a paging cause may be received at the SIM2 417 from the corresponding SIM2 network 423. According to embodiments of the present disclosure, an IMS event associated with the SIM2 417 may be determined based on the paging cause.

According to the embodiments of the present disclosure, the ML model(s) 411, at operation 804, may determine whether to enable the cross-SIM calling based on the detected IMS event. In an embodiment, the ML model(s) 411 may predict at least one of the duration and nature of the ongoing call on SIM1 415.

At operation 805, in response to or based on determining the IMS event, the cross-SIM calling may be enabled for the SIM2 417. In an embodiment, the ML model(s) 411 may enable the cross-SIM calling based on the at least one of the predicted duration and the predicted nature of the ongoing call on SIM1 415.

At operation 806, according to embodiments of the present disclosure, the cross-SIM calling is enabled by registering the IMS services of SIM2 417 using the data connection of SIM1 415. Consequently, the SIM2 417 becomes active and reachable.

At operation 807, the UE 401 is able to receive incoming calls or SMS.

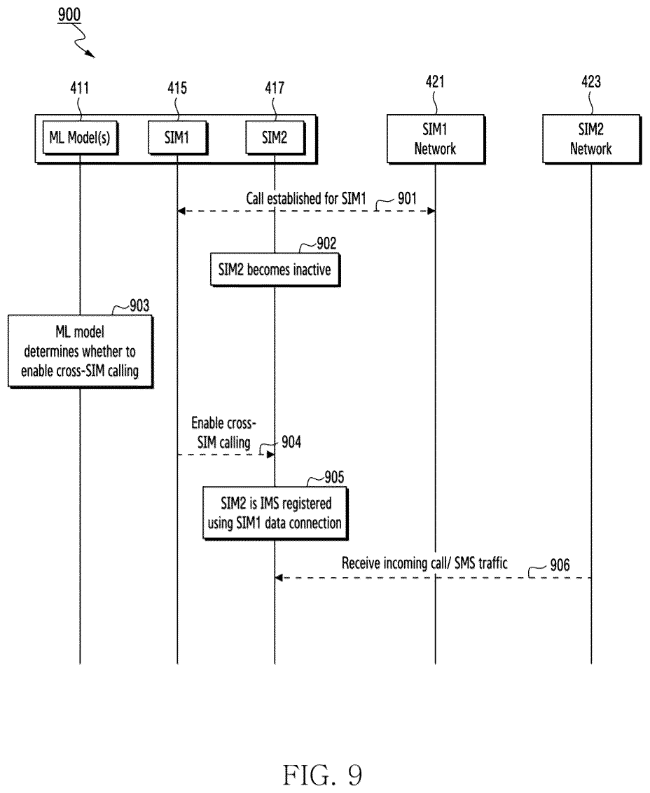

FIG. 9 is a schematic diagram 900 depicting another example flow of operations for implementing the method for managing communication in the UE 401, according to an embodiment of the present disclosure.

As depicted in FIG. 9, at operation 901, a call may be established using the SIM1 415. At operation 902, during the ongoing call on SIM1 415, the SIM2 417 becomes inactive.

In an example, at operation 903, the ML model(s) 411 (at operation 804) may determine whether to enable the cross-SIM calling. In an embodiment, the ML model(s) 411 determines whether to enable the cross-SIM calling based on a prediction of at least one of the duration and nature of the ongoing call on SIM1 415.

At operation 904, cross-SIM calling may be enabled for the SIM2 417. In an embodiment, the ML model(s) 411 may enable the cross-SIM calling based on the at least one of the predicted the duration and the predicted nature of the ongoing call on SIM1 415.

At operation 905, according to embodiments of the present disclosure, the cross-SIM calling is enabled by registering the IMS services of SIM2 417 using the data connection of SIM1 415. Consequently, the SIM2 417 becomes active and reachable.

At operation 906, the UE 401 is able to receive incoming calls or SMS.

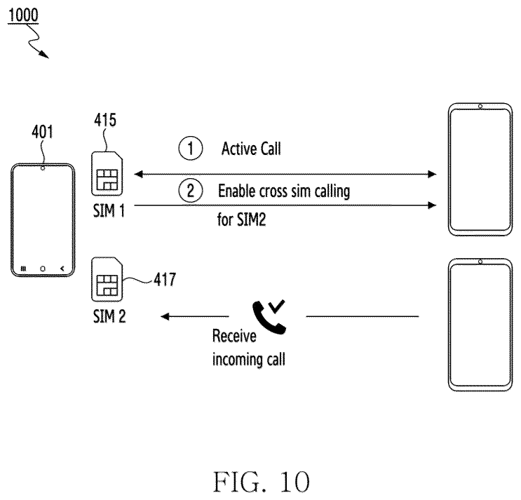

FIG. 10 is schematic diagram 1000 depicting an example use case implementing the method for managing communication in the UE 401, according to an embodiment of the present disclosure.

As depicted in FIG. 10, while the UE 401 is engaged in an active call, using the SIM1 415, with the first device 1101, the cross-SIM calling for SIM2 417 may be enabled according to the embodiments of the present disclosure such that high-priority communications such as ‘one time passwords’ (OTPs) or an emergency call may be received on the SIM2 417 during an ongoing call on the SIM1 415. According to embodiments of the present disclosure, enabling the cross-SIM calling may be optimized to reduce the excessive power consumption by the UE 401.

The present disclosure may provide enabling the receiving of high-priority communications on the SIM2 417 during an ongoing call on the SIM1 415; preventing excessive power consumption by the UE 401 in enabling the cross-SIM calling thereby encouraging users to utilize the feature; or enabling mid-range DSDS devices to act like ‘dual sim active’ (DSDA) devices with lower cost involved.

In an embodiment, specification in 3GPP TS 36.331 version 17.0.0 Release 17 pertaining to pagingCause may be extended to support more details of sub-parameters on IMS events. The current support of pagingCause in Release 17 includes only an indication of whether the paging is for an IMS event or not. The pagingCause does not include any detailed information on whether the paging is for Call or SMS, etc. The pagingCause indicates whether the Paging message originated due to the IMS voice. In a case that the field is present and an upper layer indicates the support of pagingCause, it may imply that a corresponding paging entry is for the IMS voice. In a case that the field is not present but pagingRecordList-v1700 is present, it may imply that the corresponding paging entry is for a service other than the IMS voice. In other cases, the pagingCause may remain undetermined.

In embodiments, a method (600) for managing communication in a user equipment (UE) (401) having a plurality of subscriber identity modules (SIMs) is provided. The method includes identifying (601), by the UE (401), an occurrence of a current calling event associated with a first SIM (415) among the plurality of SIMs of the UE (401); detecting (603), by the UE (401), during the occurrence of the current calling event, an internet protocol multimedia subsystem (IMS) event associated with a second SIM (417) among the plurality of SIMs of the UE (401); and in response to detecting the IMS event, enabling (605), by the UE (401), cross-SIM calling for the second SIM (417) based on information associated with the IMS event.

According to an embodiment, detecting the IMS event includes monitoring, by the UE (401), reception of paging messages for the second SIM from a connected network; determining, by the UE (401), a paging cause associated with a received paging message; and detecting, by the UE (401), the IMS event based on the determined paging cause.

According to an embodiment, determining the paging cause includes determining whether the paging message originated due to the IMS event.

According to an embodiment, enabling the cross-SIM calling is based on the paging cause.

According to an embodiment, enabling the cross-SIM calling includes determining, via a call pattern machine learning (ML) model, a pattern of one or more calling events at the UE, the pattern comprising a nature, a duration, and a frequency of the one or more calling events at the UE; and determining, via a call preference ML model, whether to enable the cross-SIM calling based on the determined pattern.

According to an embodiment, enabling the cross-SIM calling includes: predicting, via the call pattern ML model, at least one of a duration and a nature of the current calling event based on the determined pattern of the one or more calling events at the UE; and enabling the cross-SIM calling based on the at least one of the predicted duration and the predicted nature of the current calling event.

According to an embodiment, enabling the cross-SIM calling includes: activating the second SIM from an inactive state of the second SIM; and allowing initiation of a second calling event, apart from the current calling event, for the second SIM of the UE.

According to an embodiment, activating the second SIM includes registering IMS services of the second SIM using a data connection of the first SIM.

In embodiments, a system (403) for managing communication in a user equipment (UE) having a plurality of subscriber identity modules (SIMs) is provided. The system includes a call-status module (501) configured to identify, by the UE, an occurrence of a current calling event associated with a first SIM among the plurality of SIMs of the UE; a second SIM status module (503) configured to detect, by the UE, during the occurrence of the current calling event, an internet protocol multimedia subsystem (IMS) event associated with a second SIM among the plurality of SIMs of the UE; and a call-enabling module (505) configured, in response to detecting the IMS event, to enable the cross-SIM calling for the second SIM based on information associated with the IMS event.

According to an embodiment, the call-status module is configured to monitor, by the UE, reception of paging messages for the second SIM from a connected network; determine, by the UE, a paging cause associated with a received paging message; and detect, by the UE, the IMS event based on the determined paging cause.

According to an embodiment, the call-status module is configured to determine whether the paging message originated due to the IMS event.

According to an embodiment, the call-enabling module is configured to enable the cross-SIM calling based on the paging cause.

According to an embodiment, the call-enabling module is configured to determining, via a call pattern machine learning (ML) model, a pattern of one or more calling events at the UE, the pattern comprising a nature, a duration, and a frequency of the one or more calling events at the UE; and determine, via a call preference ML model, whether to enable the cross-SIM calling based on the determined pattern.

According to an embodiment, the call-enabling module is configured to predict, via the call pattern ML model, at least one of a duration and a nature of the current calling event based on the predicted pattern for the one or more calling events at the UE; and enable the cross-SIM calling based on the at least one of the predicted duration and the predicted nature of the current calling event.

According to an embodiment, the call-enabling module is configured to: activate the second SIM from an inactive state of the second SIM; and allow initiation of a second calling event, apart from the current call, for the second SIM of the UE.

According to an embodiment, call-enabling module is configured to register IMS services of the second SIM using a data connection of the first SIM.

In embodiments, a method performed by a user equipment (UE) having a plurality of subscriber identity modules (SIMs) is provided. The method includes performing, by the UE, a connection establishment procedure for a call associated with a first SIM among the plurality of SIMs of the UE; detecting, by the UE, while the call is provided on the first SIM, an internet protocol multimedia subsystem (IMS) event associated with a second SIM among the plurality of SIMs of the UE; and in response to detecting the IMS event, enabling, by the UE, cross-SIM calling for the second SIM based on information associated with the IMS event.

According to an embodiment, wherein detecting the IMS event includes monitoring, by the UE (401), reception of paging messages for the second SIM from a connected network while the call is provided on the first SIM; determining, by the UE (401), a paging cause associated with a paging message for the second SIM received while the call is provided on the first SIM; and detecting, by the UE (401), the IMS event based on the determined paging cause.

According to an embodiment, determining the paging cause includes determining whether the paging message originated due to the IMS event.

According to an embodiment, the IMS event is detected by identifying that the paging message includes information element (IE) for the paging cause and the IE indicates that the paging message is originated due to the IMS event.

According to an embodiment, enabling the cross-SIM calling includes determining, via a call pattern machine learning (ML) model, a pattern of one or more calls at the UE, the pattern comprising a nature, a duration, and a frequency of the one or more calls at the UE; and determining, via a call preference ML model, whether to enable the cross-SIM calling based on the determined pattern.

According to an embodiment, enabling the cross-SIM calling includes predicting, via the call pattern ML model, at least one of a duration or a nature of the call on the first SIM based on the determined pattern of the one or more calls at the UE; and enabling the cross-SIM calling based on the at least one of the predicted duration and the predicted nature of the call on the first SIM.

According to an embodiment, enabling the cross-SIM calling includes activating the second SIM from an inactive state of the second SIM; and performing a communication based on a second call, apart from the call on the first SIM, established for the second SIM of the UE.

According to an embodiment, activating the second SIM includes registering IMS services of the second SIM using a data connection of the first SIM.

In embodiments, a user equipment (UE) having a plurality of subscriber identity modules (SIMs) is provided. The UE includes at least one processor comprising processing circuitry; and memory storing instructions that, when executed by the at least one processor individually or collectively, cause the UE to perform, by the UE, a connection establishment procedure for a call associated with a first SIM among the plurality of SIMs of the UE; detect, by the UE, while the call is provided on the first SIM, an internet protocol multimedia subsystem (IMS) event associated with a second SIM among the plurality of SIMs of the UE; and in response to detecting the IMS event, enable, by the UE, cross-SIM calling for the second SIM based on information associated with the IMS event.

According to an embodiment, the instructions, when executed by the at least one processor individually or collectively, cause the UE to monitor, by the UE, reception of paging messages for the second SIM from a connected network while the call is provided on the first SIM; determine, by the UE, a paging cause associated with a paging message for the second SIM received while the call is provided on the first SIM; and detect, by the UE, the IMS event based on the determined paging cause.

According to an embodiment, the IMS event is detected by identifying that the paging message includes information element (IE) for the paging cause and the IE indicates that the paging message is originated due to the IMS event.

According to an embodiment, the cross-SIM calling is enabled based on the paging cause.

According to an embodiment, the instructions, when executed by the at least one processor individually or collectively, cause the UE to determining, via a call pattern machine learning (ML) model, a pattern of one or more calls at the UE, the pattern comprising a nature, a duration, and a frequency of the one or more calls at the UE; and determine, via a call preference ML model, whether to enable the cross-SIM calling based on the determined pattern.

According to an embodiment, the instructions, when executed by the at least one processor individually or collectively, cause the UE to activate the second SIM from an inactive state of the second SIM by registering IMS services of the second SIM using a data connection of the first SIM; and perform a communication based on a second call, apart from the current call, established for the second SIM of the UE.

In embodiments, a non-transitory computer-readable storage medium is provided. The non-transitory computer-readable storage medium stores instructions that, when executed by a processor, cause a user equipment (UE) having a plurality of subscriber identity modules (SIMs), to perform operations including performing, by the UE, a connection establishment procedure for a call associated with a first SIM among the plurality of SIMs of the UE; detecting, by the UE, while the call is provided on the first SIM, an internet protocol multimedia subsystem (IMS) event associated with a second SIM among the plurality of SIMs of the UE; and in response to detecting the IMS event, enabling, by the UE, cross-SIM calling for the second SIM based on information associated with the IMS event.

In the present disclosure, unless specifically stated otherwise, the use of the singular includes the plural, and the use of “or” means “and/or.” Furthermore, the use of the terms “including” or “having” is not limiting. Any range described herein will be understood to include the endpoints and all values between the endpoints. Features of the disclosed embodiments may be combined, rearranged, omitted, etc., within the scope of the disclosure to produce additional embodiments. Furthermore, certain features may sometimes be used to advantage without a corresponding use of other features.

While at least one example embodiment has been presented in the foregoing detailed description, a vast number of variations exist.

What is claimed is:

1. A method performed by a user equipment (UE) having a plurality of subscriber identity modules (SIMs) comprising a first SIM and a second SIM, the method comprising:
performing a connection establishment procedure for a first call associated with the first SIM;
detecting, while the first call is provided on the first SIM, an internet protocol multimedia subsystem (IMS) event associated with the second SIM; and
based on the detecting the IMS event, enabling a cross-SIM calling for the second SIM based on information associated with the IMS event.

2. The method of claim 1, wherein the detecting the IMS event comprises:
monitoring a reception of paging messages for the second SIM from a connected network while the first call is provided on the first SIM;
determining a paging cause associated with a paging message for the second SIM received while the first call is provided on the first SIM; and
detecting the IMS event based on the determined paging cause.

3. The method of claim 2, wherein the determining the paging cause comprises determining whether the paging message originated due to the IMS event.

4. The method of claim 2, wherein the detecting the IMS event comprises detecting the IMS event by identifying that the paging message includes an information element (IE) for the paging cause, and
wherein the IE indicates that the paging message is originated due to the IMS event.

5. The method of claim 1, wherein the enabling the cross-SIM calling comprises:
determining, via a call pattern machine learning (ML) model, a pattern of one or more calls at the UE, the pattern comprising a nature, a duration, and a frequency of the one or more calls at the UE; and
determining, via a call preference ML model, whether to enable the cross-SIM calling based on the determined pattern.

6. The method of claim 5, wherein the enabling the cross-SIM calling comprises:
predicting, via the call pattern ML model, at least one of a duration or a nature of the first call on the first SIM based on the determined pattern of the one or more calls at the UE; and
enabling the cross-SIM calling based on the at least one of the predicted duration or the predicted nature of the first call on the first SIM.

7. The method of claim 1, wherein the enabling the cross-SIM calling comprises:
activating the second SIM from an inactive state of the second SIM; and
performing a communication based on a second call, apart from the first call on the first SIM, established for the second SIM of the UE.

8. The method of claim 1, wherein the activating of the second SIM comprises registering IMS services of the second SIM using a data connection of the first SIM.

9. A user equipment (UE) having a plurality of subscriber identity modules (SIMs) comprising a first SIM and a second SIM, comprising:
at least one processor comprising processing circuitry; and
memory storing instructions that, when executed by the at least one processor individually or collectively, cause the UE to:
perform a connection establishment procedure for a first call associated with the first SIM;
detect, while the first call is provided on the first SIM, an internet protocol multimedia subsystem (IMS) event associated with the second SIM; and
based on detecting the IMS event, enable a cross-SIM calling for the second SIM based on information associated with the IMS event.

10. The UE of claim 9, wherein the instructions, when executed by the at least one processor individually or collectively, cause the UE to:
monitor a reception of paging messages for the second SIM from a connected network while the first call is provided on the first SIM;
determine a paging cause associated with a paging message for the second SIM received while the first call is provided on the first SIM; and
detect the IMS event based on the determined paging cause.

11. The UE of claim 10, wherein the IMS event is detected by identifying, by the UE, that the paging message includes information element (IE) for the paging cause, wherein the IE indicates that the paging message is originated due to the IMS event.

12. The UE of claim 11, wherein the cross-SIM calling is enabled based on the paging cause.

13. The UE of claim 9, wherein the instructions, when executed by the at least one processor individually or collectively, cause the UE to:
determine, via a call pattern machine learning (ML) model, a pattern of one or more calls at the UE, the pattern comprising a nature, a duration, and a frequency of the one or more calls at the UE; and
determine, via a call preference ML model, whether to enable the cross-SIM calling based on the determined pattern.

14. The UE of claim 9, wherein the instructions, when executed by the at least one processor individually or collectively, cause the UE to:
activate the second SIM from an inactive state of the second SIM by registering, by the UE, IMS services of the second SIM using a data connection of the first SIM; and
perform a communication based on a second call, apart from the first call, established for the second SIM of the UE.

15. A non-transitory computer-readable storage medium storing instructions that, when executed by a processor, cause a user equipment (UE), having a plurality of subscriber identity modules (SIMs) comprising a first SIM and a second SIM, to perform operations comprising:
performing a connection establishment procedure for a first call associated with the first SIM;
detecting, while the first call is provided on the first SIM, an internet protocol multimedia subsystem (IMS) event associated with the second SIM; and
based on the detecting the IMS event, enabling a cross-SIM calling for the second SIM based on information associated with the IMS event.

16. The non-transitory computer-readable storage medium of claim 15, wherein the operations comprise:
monitoring a reception of paging messages for the second SIM from a connected network while the first call is provided on the first SIM;
determining a paging cause associated with a paging message for the second SIM received while the first call is provided on the first SIM; and
detecting the IMS event based on the determined paging cause.

17. The non-transitory computer-readable storage medium of claim 16, wherein the operations comprise determining whether the paging message is originated due to the IMS event.

18. The non-transitory computer-readable storage medium of claim 16, wherein the operations comprise detecting the IMS event by identifying that the paging message includes an information element (IE) for the paging cause wherein the IE indicates that the paging message is originated due to the IMS event.

19. The non-transitory computer-readable storage medium of claim 15, wherein the operations comprise:
determining, via a call pattern machine learning (ML) model, a pattern of one or more calls at the UE, wherein the pattern includes a nature, a duration, and a frequency of the one or more calls at the UE; and
determining, via a call preference ML model, whether to enable the cross-SIM calling based on the determined pattern.

20. The non-transitory computer-readable storage medium of claim 19, wherein the operations comprise:
predicting, via the call pattern ML model, at least one of a duration or a nature of the first call on the first SIM based on the determined pattern of the one or more calls at the UE; and
enabling the cross-SIM calling based on the at least one of the predicted duration or the predicted nature of the first call on the first SIM.
